(19) United States
(12) Patent Application Publication
(10) Pub. No.: US 2010/0160158 A1
(43) Pub. Date: Jun. 24, 2010

(54) HEXAGONAL-CELL HONEYCOMB CARRIER BODY AND HEXAGONAL-CELL HONEYCOMB CATALYST BODY

(75) Inventors: Yosiyasu Ando, Gifu-ken (JP); Yoshihide Segawa, Kariya-shi (JP); Takeru Yoshida, Aichi-ken (JP)

Correspondence Address: NIXON & VANDERHYE, PC, 901 NORTH GLEBE ROAD, 11TH FLOOR, ARLINGTON, VA, 22203, US

(73) Assignees: Denso Corporation, Kariya-shi, Aichi-pref (JP); Toyota Jidosha Kabushiki Kaisha, , Aichi (JP)

(21) Appl. No.: 12/529,592

(22) PCT Filed: Feb. 29, 2008
(86) PCT No.: PCT/JP2008/054107

§ 371 Date: Dec. 28, 2009

(30) Foreign Application Priority Data
Mar. 2, 2007 (JP) 2007-052828

(51) Int. Cl. B01J 35/04; B32B 3/12; C04B 35/195; F01N 3/28

(52) U.S. Cl. 502/439

(57) ABSTRACT

A hexagonal-cell honeycomb carrier body, made of cordierite ceramic, for use in a carrier of a catalyst of purifying exhaust gas is disclosed as including a large number of hexagonal cells surrounded with cell walls formed in a hexagonal lattice pattern and a cylindrical skin layer covering outer circumferential sidewalls of the hexagonal cells. The hexagonal-cell honeycomb carrier body has GSA (Geometric Surface Area) of 3.5 mmW or more. A hexagonal-cell honeycomb catalyst body comprises the hexagonal-cell honeycomb carrier body and a catalyst layer which covers a surface of the hexagonal-cell honeycomb carrier body.

### TECHNICAL FIELD

The present invention relates to hexagonal-cell honeycomb carrier bodies and hexagonal-cell honeycomb catalyst bodies or more particularly, to a hexagonal-cell honeycomb carrier body, made of ceramic, and a hexagonal-cell honeycomb catalyst body comprised of the hexagonal-cell honeycomb carrier body carrying a catalyst.

### BACKGROUND ART

In the related art, there has been known a honeycomb catalyst body as a exhaust gas purifying catalyst body for purifying exhaust gases emitted from an engine of a motor vehicle or the like. The honeycomb catalyst body is comprised of a honeycomb carrier body, having cell walls formed in a honeycomb pattern to define a large number of cells and, a catalyst carried thereon. In general, a structure having the cells each formed in a squared cell shape has been widely used. Here, the catalyst is formed of catalytic metals and washcoat.

In recent years, in order to obtain improved exhaust gas-purifying performance, attempts have been made to mount the honeycomb catalyst body in a position closer to the engine than that in which the honeycomb catalyst body of the related art is mounted, thereby activating the catalyst earlier in time. In addition to such attempts, another attempt has heretofore been made for the honeycomb catalyst body to have an expanded catalyst-carrying surface area, having an increased number of cells per unit surface area of the honeycomb carrier body for improving exhaust gas-purifying performance, and increased GSA (Geometric Surface Area) per unit surface area.

However, with the honeycomb carrier body formed with the cells each having the square cell shape, increasing the number of cells per unit surface area results in reductions in an opening surface area and hydraulic diameter (that refers to the diameter of cell walls) of each cell. Thus, issues arise with the occurrence of a decrease in pressure, a drop in engine output and deterioration in fuel consumption, etc.

To address such issues, there are various attempts including a method of molding a honeycomb carrier body formed with cells each in a hexagonal cell shape (see U.S. Pat. No. 6,713,429). By molding the honeycomb carrier body with the cells each formed in the hexagonal shape, each cell can be ensured to have an adequate opening surface area and hydraulic diameter. Therefore, even if the number of cells per unit surface area with increased GSA increases purifying performance, the pressure decease can be minimized.

However, with the cell configurations having the hexagonal shapes, all cells have corner portions each formed at an obtuse angle. This causes the catalyst to be more weakly adhered to inner circumferential surfaces of the cell walls than those of the cell walls each formed in the square shape. Therefore, it is likely that the catalyst has a weakened adhesion force and flaking of the catalyst is liable to occur due to vibrations and thermal shocks or the like in use. The flaking of the catalyst directly has an adverse affect on purifying performance. Thus, a need arises to minimize the occurrence of flaking of the catalyst to a problem-free level in actual use completely.

From the above reasons, a need arises to provide a hexagonal-cell honeycomb carrier body (hereinafter suitably and merely referred to as a “hexagonal-cell carrier body”), formed with cells each having a hexagonal cell shape enabled to adequately suppress the flaking of the catalyst being carried, and a hexagonal-cell honeycomb catalyst body (hereinafter suitably and merely referred to as a “hexagonal-cell catalyst body”) comprised of the hexagonal-cell carrier body carrying thereon the catalyst.

### DISCLOSURE OF INVENTION

### SUMMARY OF THE INVENTION

The present invention has been completed with a view to addressing the above issues and has an object to provide a hexagonal-cell honeycomb carrier body, enabled to adequately suppress a catalyst from flaking, and a hexagonal-cell honeycomb catalyst body comprised of the hexagonal-cell carrier body carrying thereon the catalyst.

To achieve the above object, the present invention provides a hexagonal-cell honeycomb carrier body, made of cordierite ceramic, for use in a carrier of a catalyst of purifying exhaust gas, comprising a large number of hexagonal cells surrounded with cell walls formed in a hexagonal lattice pattern, and a cylindrical skin layer covering outer circumferential sidewalls of the hexagonal cells. The hexagonal-cell honeycomb carrier body has GSA (Geometric Surface Area) of 3.5 mm²/mm³ or more.

The hexagonal-cell honeycomb carrier body is used as the carrier of the exhaust gas purifying catalyst and has GSA of 3.5 mm²/mm³ or more. It has been discovered that selecting the hexagonal-cell honeycomb carrier body with GSA greater than the specified value enables the hexagonal-cell honeycomb carrier body to adequately minimize the flaking of catalyst.

As used herein, the term “GSA” refers to a surface area totalizing entire geometric surface areas of each cell with an inner circumferential surface of the cell wall being simplified. This surface area represents a total surface area of the cell interiors on which the catalyst is supported. With the amount of catalyst carried on the cell walls per unit surface area being maintained at a fixed level, the hexagonal-cell honeycomb carrier body has an increased GSA. This results in capability of decreasing the catalyst support quantity per unit surface area, while enabling a reduction in catalyst thickness as a whole. This allows the hexagonal-cell honeycomb carrier body to have an increased catalyst retaining force while making it possible to suppress the flaking of the catalyst.

The present invention has been completed with a focus on the GSA of the hexagonal-cell honeycomb carrier body that can contribute to catalyst-carrying and catalyst-retaining properties. It has been found that with the hexagonal-cell honeycomb carrier body having other conditions (such as, for instance, an average pore diameter, porosity, thermal expansion coefficient, etc.) held constant, increasing GSA of the hexagonal-cell honeycomb carrier body enables the suppression of flaking of the catalyst in an efficient manner. In addition, it has been discovered that selecting GSA of the hexagonal-cell honeycomb carrier body to be greater than the specified value enables the flaking of the catalyst to be stably suppressed.

Even when applied to an engine of a motor vehicle or the like with the hexagonal-cell honeycomb carrier body carrying an exhaust gas purifying catalyst, the hexagonal-cell honeycomb carrier body can have catalyst-retaining properties increased to an extent that adequately withstand stress occurring due to vibrations and thermal shocks under usage. Thus, it becomes possible to adequately suppress the occurrence of flaking of the carried catalyst.

Thus, the present invention makes it possible to provide a hexagonal-cell honeycomb carrier body that adequately suppresses the flaking of catalyst.

According to a second aspect of the present invention, there is provided a hexagonal-cell honeycomb catalyst body for purifying exhaust gases, comprising a hexagonal-cell honeycomb carrier body, made of cordierite ceramic, which has the large number of hexagonal cells surrounded with cell walls formed in a hexagonal lattice pattern and a cylindrical skin layer covering outer circumferential sidewalls of the hexagonal cells, and a catalyst layer, composed of a catalyst, which covers the surface of the hexagonal-cell honeycomb carrier body, wherein the hexagonal-cell honeycomb carrier body comprises the hexagonal-cell honeycomb carrier body defined in the first aspect of the present invention.

The hexagonal-cell honeycomb catalyst body of the present invention uses the hexagonal-cell honeycomb carrier body defined in the first aspect of the present invention, i.e., the hexagonal-cell honeycomb carrier body having superior catalyst retaining property. Therefore, the hexagonal-cell honeycomb catalyst body, having the catalyst layer composed of the catalyst carried on the surface of the hexagonal-cell honeycomb carrier body, can adequately suppress the flaking of catalyst.

With the hexagonal-cell honeycomb carrier body having GSA less than 3.5 mm²/mm³ in the first aspect of the present invention, difficulty may arise in adequately suppressing the flaking of catalyst.

With the hexagonal-cell honeycomb carrier body, further, each of the hexagonal cells has corner portions each having an R-surface with a curvature radius of 0.1 mm or more.

In this case, for instance, when applying a surface of the hexagonal-cell honeycomb carrier body with the catalyst (in catalyst layer), the catalyst can be applied in a uniform thickness. In addition, a whole of the hexagonal-cell honeycomb carrier body can have increased strength, enabling adequate strength to be ensured in a stabilized manner.

Furthermore, in order for the whole hexagonal-cell honeycomb carrier body to ensure adequate strength in a stabilized manner, as set forth above, each of the hexagonal cells may preferably have corner portions each having an R-surface with a curvature radius of 0.1 mm or more, preferably 0.15 mm or more and more preferably 0.25 mm or more (see FIG. 9 related to Example 3 described below).

Moreover, the curvature radius of the R-surface may be preferably determined to have an upper limit of 4.0 mm or less.

As used herein, the term “R-surface” refers to a curved or round surface having a given curvature.

With the hexagonal-cell honeycomb carrier body, the hexagonal-cell honeycomb carrier body may preferably have an average pore diameter of 3.5 μm or more.

If the hexagonal-cell honeycomb carrier body has the average pore diameter less than 3.5 μm, the catalyst intrudes pores of the hexagonal-cell honeycomb carrier body, causing potential difficulty in adequately obtaining improved adhesion of the catalyst due to a so-called anchor effect.

Accordingly, the hexagonal-cell honeycomb carrier body may preferably have an average pore diameter of 3.7 μm or more.

Further, the average pore diameter of the hexagonal-cell honeycomb carrier body may preferably have an upper limit of 20 μm or less with a view to enabling the hexagonal-cell honeycomb carrier body to have adequately increased strength.

With the hexagonal-cell honeycomb carrier body, the hexagonal-cell honeycomb carrier body may preferably have a thermal expansion coefficient of 1×10⁻⁶/° C. or less.

If the hexagonal-cell honeycomb carrier body has the thermal expansion coefficient exceeding a value of 1×10⁻⁶/° C., thermal stress occurs at an increased rate between the hexagonal-cell honeycomb carrier body and the catalyst carried on the hexagonal-cell honeycomb carrier body, resulting in the possibility of flaking of the catalyst to easily occur.

With the hexagonal-cell honeycomb carrier body, the hexagonal-cell honeycomb carrier body may preferably have porosity of 30% or more.

If the hexagonal-cell honeycomb carrier body has porosity less than 30%, there is the possibility of inadequately carrying the catalyst on the hexagonal-cell honeycomb carrier body.

In addition, the hexagonal-cell honeycomb carrier body may preferably have porosity of 40% or less with a view to ensuring the hexagonal-cell honeycomb carrier body to have adequately increased strength.

With the hexagonal-cell honeycomb carrier body, the hexagonal-cell honeycomb carrier body may preferably have the cells at a density of 1000 cells/inch² or less.

If the hexagonal-cell honeycomb carrier body has the cells exceeding a density of 1000 cells/inch², the presence of catalyst being carried causes clogging to occur in the cells, resulting in the possibility of increased pressure loss.

With the hexagonal-cell honeycomb catalyst body of the second aspect of the present invention, the catalyst layer, covering a corner portion of each of the hexagonal cells, may preferably have a thickness of 150 μm or less.

If the catalyst layer has the thickness exceeding a value of 150 μm, there is a fear of easily causing the flaking of the catalyst on the catalyst layer at the corner portions of each cell. In addition, the flaking of the catalyst encountered at the corner portions of each cell leads to a fear of causing the flaking of the catalyst layer of the catalyst in other areas than the corner portions.

Thus, the catalyst layer, covering a corner portion of each of the hexagonal cells, may preferably have a thickness of 100 μm or less.

With the hexagonal-cell honeycomb catalyst body, the hexagonal-cell honeycomb catalyst body may preferably have an amount of a catalyst carried on the hexagonal-cell honeycomb carrier body at a value of 350 g/l or less.

If the hexagonal-cell honeycomb catalyst body has the amount of the catalyst at the value exceeding 350 g/l, it may be difficult to control the thickness of the catalyst layer, especially, the thickness of the catalyst layer at the corner of each cell.

The amount of the catalyst carried on the hexagonal-cell honeycomb catalyst body may preferably have a lower limit value of 50 g/l or more that can ensure the catalyst to have adequately increased purifying performance.

Examples of the catalyst constituting the catalyst layer may include a composition including platinum (Pt), palladium (Pd) and rhodium (Rh) carried on alumina, ceria/zirconia composite oxides or the like.

Further, the hexagonal-cell honeycomb catalyst body of the second aspect of the present invention is manufactured using the hexagonal-cell honeycomb carrier body of the first aspect of the present invention. In this case, with the hexagonal-cell honeycomb carrier body made into the hexagonal-cell honeycomb catalyst body, there is likelihood that it becomes difficult to accurately measure various characteristics (such as GSA, average pore diameter, porosity and thermal expansion coefficient, etc.) of the hexagonal-cell honeycomb carrier body.

### BRIEF DESCRIPTION OF THE DRAWINGS

FIG. 1 is a perspective view illustrating a structure of a hexagonal-cell honeycomb carrier body of an embodiment according to the present invention.

FIG. 2 is a fragmentary enlarged view of a unit cell of the hexagonal-cell honeycomb carrier body of the embodiment shown in FIG. 1.

FIG. 3 is an illustrative view showing a cross-sectional view of the unit cell, taken in a radial direction, of the hexagonal-cell honeycomb carrier body of the embodiment shown in FIG. 1.

FIG. 4 is an illustrative view showing a cross-sectional view of the unit cell carrying thereon a catalyst layer, taken in a radial direction, of the hexagonal-cell honeycomb carrier body of the embodiment shown in FIG. 1.

FIG. 5 is an illustrative view showing the relationship between a flaking rate (%) and GSA of the hexagonal-cell honeycomb carrier body of the embodiment shown in FIG. 1.

FIG. 6 is an illustrative view showing the relationship between the flaking rate (%) and an average pore diameter (μm) of the hexagonal-cell honeycomb carrier body of the embodiment shown in FIG. 1.

FIG. 7 is an illustrative view showing the relationship between a pressure loss (kPa) and the number of cells (cells/inch²) of the hexagonal-cell honeycomb carrier body of the embodiment shown in FIG. 1.

FIG. 8 is an illustrative view showing the relationship between the flaking rate (%) and the catalyst thickness (μm) of the hexagonal-cell honeycomb carrier body of the embodiment shown in FIG. 1.

FIG. 9 is an illustrative view showing the relationship between a curvature radius of an R-surface formed at each corner of a cell and the hexagonal-cell honeycomb carrier body of the embodiment shown in FIG. 1.

### DETAILED DESCRIPTION OF THE PREFERRED EMBODIMENTS

Now, a hexagonal-cell honeycomb carrier body and hexagonal-cell honeycomb catalyst body of embodiments according to first and second aspects of the present invention will be described below in detail, with reference to the accompanying drawings. However, the present invention is construed not to be limited to particular embodiments described below and technical concepts of the present invention may be implemented in combination with other known technologies or the other technology having functions equivalent to such known technologies.

In the following description, like reference characters designate like or corresponding component parts throughout the several views. Also the following description, it is to be understood that such terms as “cylindrical”, “inner”, “outer”, “axially”, “peripheral”, “circumferential”, “equidistantly” and the like are words of convenience and are not to be construed as limiting terms.

### Embodiment

### Example 1

In this Example, the flaking rate of catalyst in the hexagonal-cell honeycomb carrier body was quantitatively evaluated using a method described below.

A plurality of hexagonal-cell honeycomb catalyst bodies was prepared with various characteristics (such as GSA (Geometric Surface Area) and average pore diameter) being different from each other. Then, a fixed amount of catalyst was carried on each hexagonal cell honeycomb carrier body, after which the flaking rate of catalyst was measured.

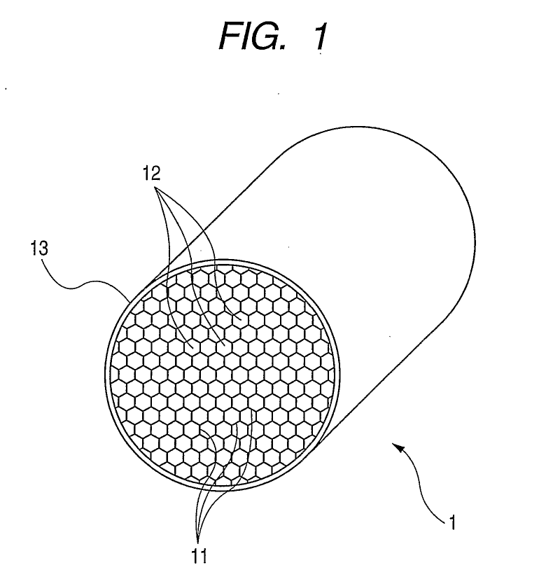

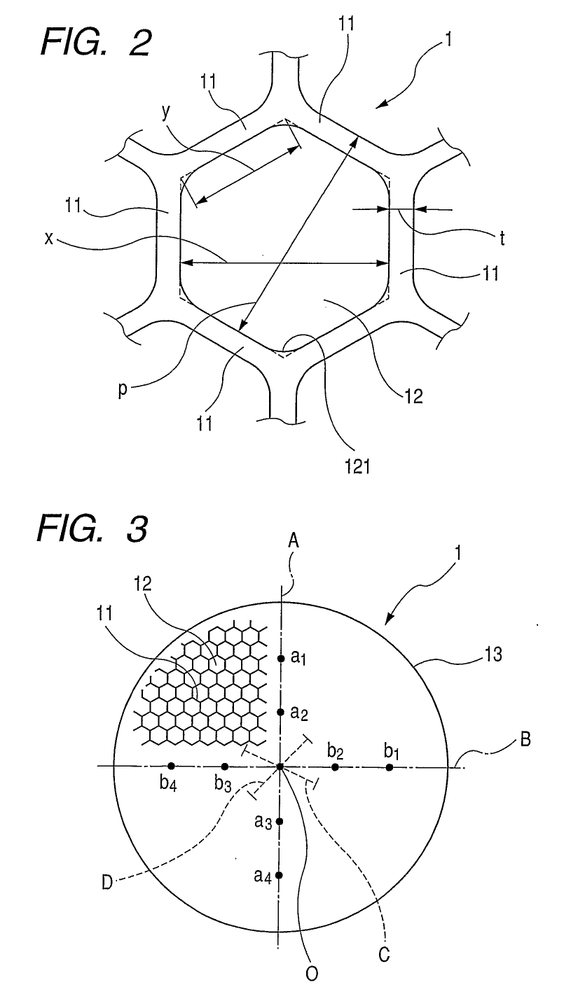

Now, a fundamental structure of the hexagonal-cell honeycomb carrier body of this Example will be described below in detail with reference to FIGS. 1 and 2.

As shown in FIG. 1, the hexagonal cell honeycomb carrier body 1, made of cordierite ceramic material, is used as a catalyst carrier of a catalyst of purifying exhaust gas. The hexagonal cell carrier 1 takes the form of a cylindrical shape and includes a large number of hexagonal cells 12, surrounded with cell walls 11 formed in a hexagonal lattice pattern, and a cylindrical skin layer 13 covering outer circumferential sidewalls of the cell walls 11. In addition, the hexagonal cell carrier 1 has a diameter of approximately 103 mm and a length of approximately 130 mm.

As shown in FIG. 2, further, the hexagonal cell 12 has corner portions 121 each formed in an R-surface. The R-surface may preferably have a curvature radius “r” of 0.1 mm or more, preferably 0.12 mm or more and more preferably 0.15 mm or more.

Moreover, each of the cell walls 11 has a cell wall thickness “t” ranging from 68 to 100 μm and a cell pitch “p” ranging from 0.82 to 1.36 mm. In addition, the cell thickness “t” and the curvature radius “r” take different values depending on GSA and the number of cells of the hexagonal cell carrier 1.

The hexagonal cell carrier 1 was manufactured using a carrier manufacturing method that included a molding step of extrusion molding a ceramics raw material to form a honeycomb compact body, a drying step of drying the honeycomb compact body, and a firing step of firing the dried honeycomb compact body.

In conducting the molding step, the ceramics raw material was extrusion molded using an extrusion molding die having slit recesses formed in a lattice pattern corresponding to the shapes of the cell walls 11.

First, the ceramic raw material, forming the honeycomb compact body, was prepared. In this Example, the ceramics raw material included a raw material powder containing kaolin, talc and alumina or the like. The raw material powder was weighed and blended in a chemical composition composed of cordierite as a principal component on a final stage. Then, the raw material powder was mixed with given amounts of water and binder such as methylcellulose or the like, thereby forming a mixture. The mixture was kneaded, thereby obtaining the ceramics raw material.

Next, the resulting ceramics raw material was extrusion molded using the extrusion-molding die, thereby forming the honeycomb compact body (in the molding step). Thereafter, the resulting honeycomb compact body was dried by microwaves (in the drying step), after which the dried honeycomb compact body was fired at a maximal temperature of approximately 1410° C. (in the firing step).

With the various steps conducted, the hexagonal cell carrier 1, shown in FIG. 1, was obtained.

In this Example, plural hexagonal cell carriers 1 were manufactured with structures altered in GSA and average pore diameter.

The hexagonal cell carriers 1 had GSA adjusted in a range from 2.7 to 4.5 mm²/mm³ upon varying the number of cells per unit surface (per inch²) of each of the hexagonal cell carriers 1. The relationship between the number of cells and GSA, used in the present Example, is shown in Table 1 listed below. Also, the number of cells, indicated in Table 1, is indicated in a unit of “cpsi (=cells/inch²)”.

Further, the average pore diameter of the hexagonal cell carriers 1 was adjusted to lie in a value ranging from 2.2 to 6.8 μm upon varying the average pore diameter of talc contained in the ceramics raw material.

TABLE 1

| Number of Cells | GSA |
|---|---|
| (cpsi) | (mm²/mm³) |
| 400 | 2.72 |
| 500 | 3.02 |
| 600 | 3.30 |
| 650 | 3.42 |
| 700 | 3.54 |
| 750 | 3.65 |
| 800 | 3.76 |
| 900 | 3.96 |
| 1000 | 4.15 |

Here, GSA of the hexagonal cell carrier 1 will be described. In the present Example, GSA of the hexagonal cell carrier 1 exhibits a geometric surface area per unit surface area and can be primarily calculated based on the cell wall thickness “t” and cell pitch “p”.

As shown in FIG. 2, an inner circumferential surface, defined with the cell walls 11 surrounding each cell 12, is regarded to have a regular hexagonal shape (with the corner portion 121 of the cell 12 regarded to lie in an area indicated by a dotted area. Then, a distance “x” (=p−t) between opposing sides is calculated using the cell wall thickness “t” and cell pitch “p”. Then, a length “y” (=x/\sqrt{3}) of each side using the distance “x” that is obtained. The hexagonal cell carrier 1 has a length direction on a simple flat surface. Therefore, upon supposing that the hexagonal cell carrier 1 has a length “L”, a surface area “S” (=6×L) of each cell can be calculated. This allows GSA of a whole of the hexagonal cell carrier 1 to be introduced based on the number of cells, and GSA per unit surface area is introduced based on a volume of the hexagonal cell carrier 1.

Further, with the present Example, the cell wall thickness “t” and cell pitch “p” of the hexagonal cell carrier 1 were measured in a method based on JASO (Japanese Automobile Standards Organization) M505-87.

As shown in FIG. 3, for the cell wall thickness “t”, the thickness of the cell wall 11 was measured at positions (a₁, a₂, O, a₃, a₄) and (b₁, b2, O, b₃, b₄) on provisional lines A and B, crossing the center point “O” and divided in two halves, which are equally divided into five points, with an average value being treated as the cell wall thickness “t”.

As shown in FIG. 3, further, for the cell pitch “p”, lengths equivalent to contiguous 20 cell pitches on provisional lines C and D crossing the center “O” were measured with an average for one cell component being treated as the cell pitch “p”.

The average pore diameter of the hexagonal cell carrier 1 was measured upon conducting a mercury intrusion technique using a porosity meter (manufactured and soled by Shimadzu Corporation under a type “9320-PC2”). Mercury porosimetry is based on the principle of a capillary tube when fine pores are immersed into a liquid. As will be apparent from a Washburn's equation, the average pore diameter of the hexagonal cell carrier 1 is calculated using information resulting from a physical value or directly measured value indicative of a pressure, surface tension, contact angle and a volume or the like of mercury penetrated into the fine pores.

Further, other characteristics, such as, for instance, porosity and thermal expansion coefficient, of the hexagonal cell carrier 1 were kept at nearly fixed values. In the present Example, the porosity was selected to lie in a value from 30 to 35% and the thermal expansion coefficient was selected to lie in a range of approximately 0.5×10⁻⁶/° C.

Furthermore, the porosity was calculated based on a pore distribution measured by the porosity meter in the same method conducted for calculating the average pore diameter. In addition, the thermal expansion coefficient was measured using thermal dilatometer (manufactured and sold by ULVAC Co., Ltd under a type of DLY9600). In measuring, a sample with a length of 50 mm was heated from room temperature up to a temperature of 800° C., after which the expansion and contraction of the hexagonal cell carrier 1 were measured using a differential transformer, thereby obtaining an average thermal expansion coefficient for a temperature ranging from 40 to 800° C.

Next, a catalyst was carried on the hexagonal cell carrier 1.

A catalyst material to be carried was prepared. In the present Example, 50 g of γ-alumina powder carrying 1 wt % of Rh, 100 g of ceria-zirconia powder carrying 3 wt % of Pt, 100 g of alumina sol (with 10 wt % of alumina dry solids content manufactured and sold by Nissan Chemical Industries, Ltd.), and a suitable amount of water were blended. The resulting blend was mixed in a ball mill for two hours, thereby obtaining a slurry-like catalyst material.

Next, the slurry-like catalyst material is filled in the hexagonal cell carrier 1, after which suction is conducted to discharge an excess of catalyst material. Then, the hexagonal cell carrier 1 was dried at a temperature of 80° C. for 30 minutes and, thereafter, fired at a temperature of 500° C. for 2 hours.

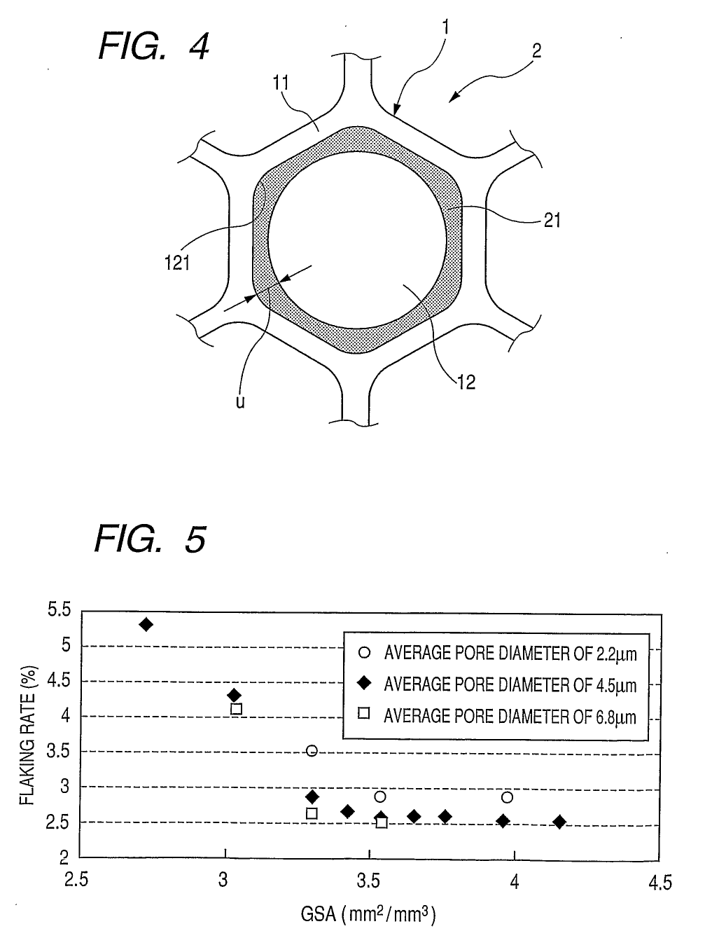

Thus, the hexagonal-cell honeycomb catalyst body 2, as shown in FIG. 4, was obtained.

As shown in FIG. 4, the hexagonal-cell honeycomb catalyst body 2 had the hexagonal-cell honeycomb carrier body 1 and a catalyst layer 21 composed of catalyst covering the surface of the hexagonal-cell honeycomb carrier body 1. In addition, the catalyst was carried on the hexagonal-cell honeycomb carrier body 1 at a rate of 270 g/l for the hexagonal-cell honeycomb carrier body 1.

Next, the flaking rate of catalyst for the resulting hexagonal-cell honeycomb catalyst body 2 was measured.

First, the hexagonal-cell honeycomb catalyst body 2 was cut at a position, spaced by a distance of 20 mm from an end face thereof, into a round slice with a length of 18 mm. Then, the hexagonal-cell honeycomb catalyst body 2, cut into a round slice, was cut into nine cubes each 18 mm on a side, thereby obtaining specimens. Subsequently, five cubes, randomly selected from the nine cubes being cut out, were heated under a condition at a temperature of 1000° C. for 5 hours in atmosphere. Thereafter, dry weights of these specimens were measured with a dry weight before the test being assigned to be W₁.

Next, an ultrasonic wave is applied to the specimens in water using an ultrasonic washing machine. The ultrasonic wave was applied to the specimens placed on an ultrasonic transducer under a condition of 200 W and an output frequency of 40 kHz for 10 minutes. Subsequently, the dry weights of the specimens were measured with the weight after the test being assigned to be W₂.

A difference (W₁−W₂) between the dry weight W₁ before the test and the weight W₂ after the test represents a weight of catalyst flaked from the specimens when subjected to the ultrasonic wave. Therefore, the flaking rate (%) of catalyst can be derived by ratio of the weight (W₁−W₂) of catalyst flaked from the specimen to the dry weight W₁ before the test. Thus, the flaking rate (%) of catalyst can be obtained in a formula expressed as:

{(W₁−W₂)/W₁}×100

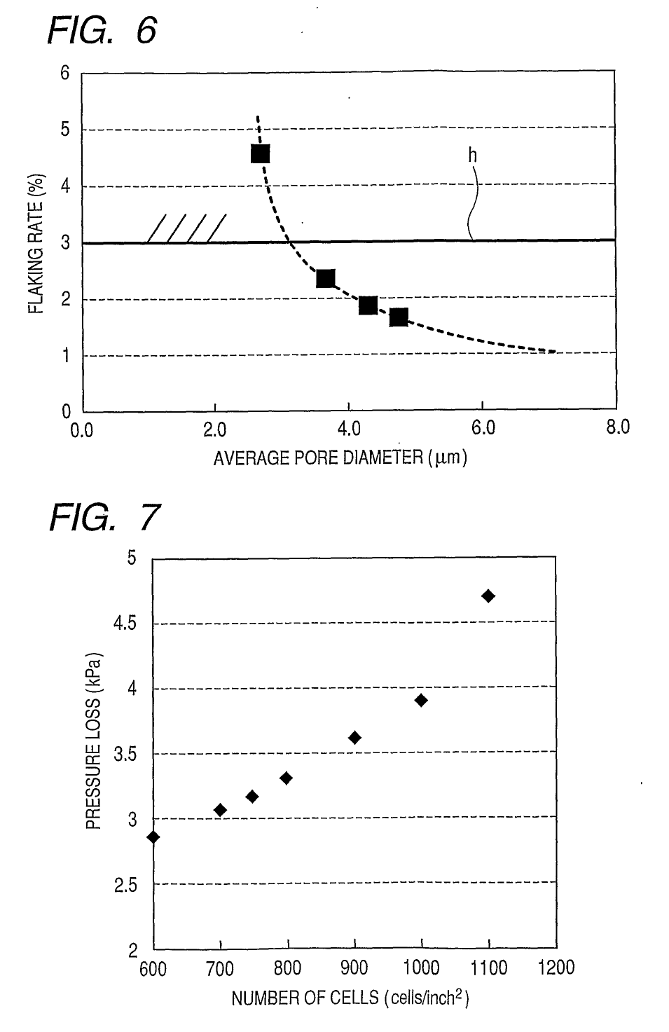

Next, evaluation results on the flaking rate of the catalyst are shown in FIGS. 5 and 6.

FIG. 5 shows the relationship between GSA (mm²/mm³) of each hexagonal cell carrier 1 and the flaking rate (%) of the catalyst. In addition, in FIG. 5, the flaking rates are plotted for average pore diameters (2.2 μm, 4.5 μm and 6.8 μm), respectively. Also, the hexagonal cell carriers 1 had the porosities and thermal expansion coefficients as discussed above.

It is clear from FIG. 5 that regardless of the size of the average pore diameter, the greater the GSA of the hexagonal cell carrier 1, the lower will be the flaking rate of the catalyst. Further, in case of any of average pore diameters, selecting the hexagonal cell carriers 1 with GSA of 3.5 mm²/mm³ or more enables a remarkable suppression of a reduction in the flaking rate of the catalyst. As a consequence, it is preferable to allow the hexagonal cell carriers 1 to have GSA of 3.5 mm²/mm³ or more.

FIG. 6 shows the relationship between the average pore diameter (μm) of the hexagonal cell carrier 1 and the flaking rate of the catalyst. In addition, the GSA of the hexagonal cell carrier 1 was selected to lie at a value of 4 mm²/mm³. Moreover, the porosities and thermal expansion coefficients had values discussed above.

It will be apparent from FIG. 6 that the greater the average pore diameter (μm) of the hexagonal cell carrier 1, the lower will be the flaking rate of the catalyst. In addition, it is preferable for the flaking rate of the catalyst to be of 3% or less (on a line “h” in FIG. 6). To this end, the average pore diameter (μm) of the hexagonal cell carrier 1 may be preferably selected to be 3.5 μm or more.

In the present Example, further, evaluations were conducted on the number of cells and a pressure loss of the hexagonal cell carrier 1. FIG. 7 shows the relationship between the number of cells (cells/inch²) and the pressure loss (kPa) of the hexagonal cell carrier 1. In addition, the average pore diameter (μm) of the hexagonal cell carrier 1 was selected to lie in a value of 4.5 μm. Moreover, the porosities and thermal expansion coefficients had values discussed above.

It will be apparent from FIG. 7 that the greater the number of cells of the hexagonal cell carrier 1, the greater will be the pressure loss. In particular, the pressure loss remarkably increases with the number of cells reaching a value around 1000 cells/inch². Accordingly, it is preferable for the hexagonal cell carrier 1 to have the number of cells at a value of 1000 cells/inch² or less.

Further, while the present Example has been described above with reference to an example of the hexagonal-cell honeycomb catalyst body 2 employing the hexagonal cell carrier 1 having the cells 12 formed with the corner portions 121 each having the R-surface, the hexagonal-cell honeycomb catalyst body 2 may be implemented in an alternative employing the hexagonal cell carrier 1 having the cells 12 formed with the corner portions 121 on each of which no R-surface is formed. Even such an alternative can adequately have the advantageous effects of the present invention as set forth above.

### Example 2

In this Example 2, plural hexagonal-cell honeycomb catalyst bodies 2 were prepared using the hexagonal cell carriers 1 prepared in Example 1 with the corner portion 121 of each cell 12 having the catalyst layer 21 with a thickness “u” (see FIG. 4) being altered depending on the amount of catalyst being carried, upon which the flaking rates of the catalysts were measured.

Further, the hexagonal cell carriers 1, adopted in present Example, had the GSA of 3.3 mm²/mm³ with the average pore diameter of 4.5 μm. In addition, the porosities and thermal expansion coefficients had values discussed above.

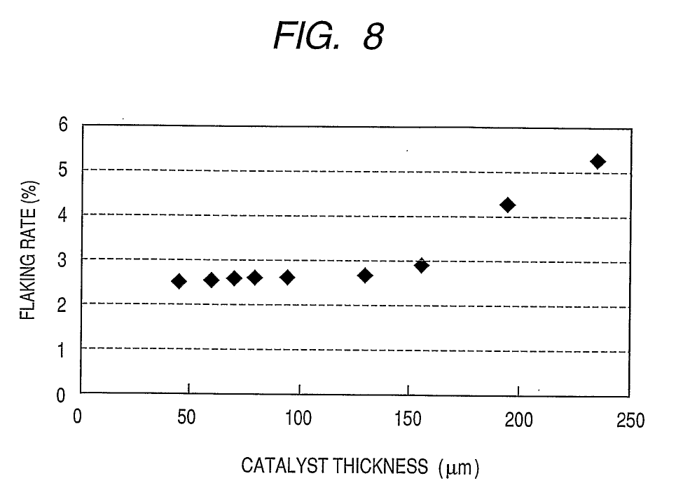

FIG. 8 shows the relationship between the catalyst thickness (μm) of the catalyst layer 21 of the corner portion 121 of each cell 12 and the flaking rate (%) of the catalyst.

It will be apparent from FIG. 8 that the flaking rate of the catalyst rapidly increases with the catalyst thickness exceeding a value around 150 μm. Especially, there occurs a phenomenon in that as the catalyst thickness reaches a value of approximately 200 μm, not only a flaking of the catalyst layer 21 occurs at the corner portion 121 of the cell 12 but also a flaking of the catalyst layer 21 occurs in other area than the corner portion 121.

Further, when experimentally checking the flaking of the catalyst layer 21, it has been demonstrated that with the catalyst layer formed in a thickness of a little less than 100 μm, the catalyst layer 21 is merely encountered with a crack with no occurrence of flaking of the catalyst layer 21 even under a situation where no R-surface is formed on each of the corners 121 of each cell 12. In addition, it has been confirmed that with the R-surface formed on each of the corners 121 of each cell 12, the catalyst layer 21 has a thickness formed in a further uniformalized manner with a lessened occurrence of cracks.

From the result shown in FIG. 8, accordingly, it is turned out that the catalyst layer 21, formed on each corner portion 121 of the cells 12, may preferably have a thickness of 150 μm or less and, more preferably, 100 μm or less.

### Example 3

With this Example 3, upon using the hexagonal cell carriers 1 manufactured in the same method as that of Example 1, isostatic strengths of the hexagonal cell carriers 1 were measured with the cells 12 having the corners 121 formed with the R-surfaces varied in various curvature radii.

Further, the hexagonal cell carriers 1, adopted in this Example, had cell wall thicknesses “t” each in a value of 3.0 mil (=0.077 mm), GSA in values of 3.54 mm²/mm³ and 3.76 mm²/mm³, and a porosity of 38.6%.

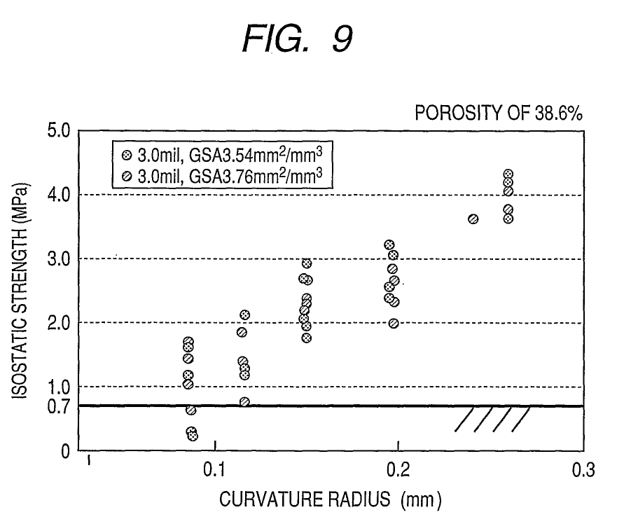

FIG. 9 is a graph showing the relationship between the curvature radius (mm) of an R-surface, formed on the corner portion 121 of each cell 12, and isostatic strength (MPa) of the hexagonal cell carrier 1.

As will be apparent from FIG. 9, with the R-surface having a small curvature radius less than 0.1 mm, some of the hexagonal cell carriers 1 have isostatic strengths exceeding one measure of a strength value (0.7 MPa) regarded to be adequate in actual use and the other of the hexagonal cell carriers 1 have isostatic strengths marking lower values less than such a measure of the strength value. Thus, all of the hexagonal cell carriers 1 become hard to ensure adequate strength in a stable manner. This is considered because the corner portions 121 of the cells 12 are damaged due to stress concentrations occurring in deteriorated portions of the cells 12 of the hexagonal cell carriers 1.

Meanwhile, with the R-surface having a curvature radius of 0.1 mm or more, all of the hexagonal cell carriers 1 have isostatic strengths exceeding the measure of the strength value of 0.7 MPa, enabling to ensure adequate strength in a stable manner.

From the result shown in FIG. 9, accordingly, it is turned out that in order to ensure the hexagonal cell carrier 1 to have adequate strength in a stable manner, the R-surface formed on each corner portion 121 of each cell 12 may preferably have a curvature radius of 0.1 mm or more and, preferably, 0.15 mm or more and, more preferably, 0.25 mm or more.

While the specific embodiment of the present invention has been described in detail with reference to various Examples, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

1. A hexagonal-cell honeycomb carrier body, made of cordierite ceramic, for use in a carrier of a catalyst of purifying exhaust gas, comprising:
a large number of hexagonal cells surrounded with cell walls formed in a hexagonal lattice pattern; and
a cylindrical skin layer covering outer circumferential sidewalls of the hexagonal cells;
wherein the hexagonal-cell honeycomb carrier body has GSA (Geometric Surface Area) of 3.5 mm²/mm³ or more.

2. The hexagonal-cell honeycomb carrier body according to claim 1, wherein:
each of the hexagonal cells has corner portions each having an R-surface with a curvature radius of 0.1 mm or more.

3. The hexagonal-cell honeycomb carrier body according to claim 1, wherein:
each of the hexagonal cells has corner portions each having an R-surface with a curvature radius of 0.15 mm or more.

4. The hexagonal-cell honeycomb carrier body according to claim 1, wherein:
each of the hexagonal cells has corner portions each having an R-surface with a curvature radius of 0.25 mm or more.

5. The hexagonal-cell honeycomb carrier body according to claim 1, wherein:
the hexagonal-cell honeycomb carrier body has pores whose average pore diameter is 3.5 μm or more.

6. The hexagonal-cell honeycomb carrier body according to claim 1, wherein:
the hexagonal-cell honeycomb carrier body has an average pore diameter of 3.7 μm or more.

7. The hexagonal-cell honeycomb carrier body according to claim 1, wherein:
the hexagonal-cell honeycomb carrier body has a thermal expansion coefficient of 1×10⁻⁶/° C. or less.

8. The hexagonal-cell honeycomb carrier body according to claim 1, wherein:
the hexagonal-cell honeycomb carrier body has a porosity of 30% or more.

9. The hexagonal-cell honeycomb carrier body according to claim 1, wherein:
the hexagonal-cell honeycomb carrier body consists of cells whose density is 1000 cells/inch² or less.

10. A hexagonal-cell honeycomb catalyst body for purifying exhaust gases, comprising:
a hexagonal-cell honeycomb carrier body, made of cordierite ceramic, which has a large number of hexagonal cells surrounded with cell walls formed in a hexagonal lattice pattern and a cylindrical skin layer covering outer circumferential sidewalls of the hexagonal cells; and
a catalyst layer which covers a surface of the hexagonal-cell honeycomb carrier body;
wherein the hexagonal-cell honeycomb carrier body comprises the hexagonal-cell honeycomb carrier body defined in one of claims 1 to 9.

11. The hexagonal-cell honeycomb catalyst body according to claim 10, wherein:
the catalyst layer, having an area covering a corner portion of each of the hexagonal cells, has a thickness of 150 μm or less.

12. The hexagonal-cell honeycomb catalyst body according to claim 10, wherein:
the catalyst layer, having an area covering a corner portion of each of the hexagonal cells, has a thickness of 100 μm or less.

13. The hexagonal-cell honeycomb catalyst body according to claim 10, wherein:
the hexagonal-cell honeycomb catalyst body has 350 g/l or less catalyst carried on the hexagonal-cell honeycomb carrier body.
